(19) United States
(12) Patent Application Publication
(10) Pub. No.: US 2023/0162750 A1
(43) Pub. Date: May 25, 2023

(54) NEAR-FIELD AUDIO SOURCE DETECTION FOR ELECTRONIC DEVICES

(71) Applicant: Apple Inc., Cupertino, CA (US)

(72) Inventors: Prateek MURGAI, San Francisco, CA (US); Ashrith DESHPANDE, San Jose, CA (US)

(21) Appl. No.: 17/531,687

(22) Filed: Nov. 19, 2021

(51) Int. Cl. G10L 21/0208; G10L 25/78; G10L 15/22; H04R 1/40

(52) U.S. Cl. CPC G10L 21/0208; G10L 25/78; G10L 15/22; H04R 1/406

(57) ABSTRACT

Aspects of the subject technology provide for identifying a portion of one or more audio signals from one or more microphones of an electronic device that correspond to a sound-generating component of the electronic device. The identification of the portion of the audio signals may be based on a near-field impulse response for the sound-generating component and the one or more microphones. The electronic device may then be operated based on the audio signals and the identified portion of the audio signals. The sound-generating component may be a speaker, and operating the electronic device based on the audio signals and the identified portion of the audio signals may include performing a residual echo suppression by removing the identified portion of the audio signals from the audio signals, and transmitting, storing, and/or otherwise processing the residual echo suppressed audio signals.

### TECHNICAL FIELD

The present description relates generally to processing audio signals, including, for example, near-field audio source detection for electronic devices.

### BACKGROUND

An electronic device may include multiple microphones. The multiple microphones may produce audio signals which include sound from a source, such as a user speaking to the device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a block diagram of an example electronic device with a sound-generating component in accordance with one or more implementations.

FIG. 2 illustrates a block diagram of the example electronic device of FIG. 1 generating sound with another sound-generating component in accordance with one or more implementations.

FIG. 3 illustrates a block diagram of the example electronic device of FIG. 1 being contacted by an external object in accordance with one or more implementations.

FIG. 4 illustrates a block diagram of an example architecture for residual echo suppression in accordance with one or more implementations.

FIG. 5 illustrates a block diagram of another example architecture for residual echo suppression in accordance with one or more implementations.

FIG. 6 illustrates a block diagram of an example architecture for operating an electronic device based, in part, on an identified near-field audio source in accordance with one or more implementations.

FIG. 7 illustrates a block diagram of another example architecture for operating an electronic device based, in part, on an identified near-field audio source in accordance with one or more implementations.

FIG. 8 illustrates a flow diagram of example process for operating an electronic device based, in part, on an identified near-field audio source in accordance with one or more implementations.

FIG. 9 illustrates a flow diagram of an example process for residual echo suppression in accordance with one or more implementations.

FIG. 10 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

An electronic device may include multiple microphones. The microphones may produce audio signals corresponding to sounds from one or more audio sources. For example, the audio sources may include sources that are external to the electronic device, such as one or more of a user who is speaking to the device, a bystander who is not the user of the device but whose voice may be captured by device microphones, and/or environmental noise (e.g., wind, traffic, and the like). The audio sources that are external to the electronic device may be far-field audio sources for one or more (e.g., all) of the microphones of the electronic device. A far-field audio source may be a source for which the sound received from the audio source at the various microphones of the electronic device differs in phase, but has substantially the same energy. In one or more implementations, a direction-of-arrival of a far-field audio source can be determined based on the different phases of the received sound at the various microphones of the device, and a presumption that the energy of the received sound is substantially the same at the various microphones (e.g., an assumption that the audio source is a far-field source).

However, audio signals generated by the microphones may also include portions that correspond to sounds from one or more near-field audio sources. For example, near-field audio sources can include audio sources that are internal and/or integral to the electronic device. For example, near-field audio sources can include sound-generating components of the electronic device, such as one or more speakers of the electronic device, one or more fans (e.g., cooling fans) of the electronic device, and/or one or more haptic components (e.g., piezoelectric components that generate haptic feedback) of the electronic device.

Aspects of the subject technology provide for distinguishing, with an electronic device having multiple microphones, near-field and far-field audio sources. Because the relative locations of device components with respect to the various microphones of an electronic device are known and fixed, near-field impulse response functions can be predetermined for each microphone/near-field source pair, each of which can also have a direction-of-arrival label. In one or more implementations, far-field impulse response functions can also be predetermined for one or more far-field locations at which an audio source may be expected to be located at one or more times during operation of the electronic device.

In one or more implementations, using at least the near-field impulse response functions, the electronic device can identify audio signals that correspond to one or more near-field source directions-of-arrival. As described in further detail hereinafter, once the near-field and/or far-field audio sources have been distinguished in the audio signals, various device operations can leverage the audio signals and labels corresponding to the distinguished audio sources, such as for residual echo suppression, blind source separation, automatic noise cancellation, acoustic scene mapping, voice assistance, audio and/or video conferencing, telephony, or the like.

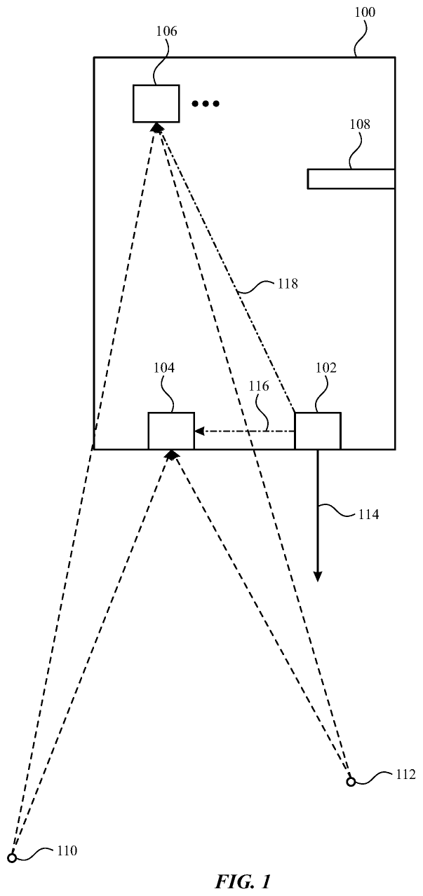

FIG. 1 illustrates an example electronic device in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example of FIG. 1, an electronic device 100 includes sound-generating components such as a speaker 102 and a sound-generating component 108. The sound-generating component 108 may be, for example, a fan (e.g., a cooling fan), a haptic component (e.g., a piezoelectric actuator), or any other device that generates sound as an intended audio output or as an unintended audio output. Although a single speaker 102 and a single sound-generating component 108 are shown in FIG. 1, it is appreciated that the electronic device 100 may include one, two, three, more than three, or generally any number of speakers and/or other sound-generating components.

As shown in FIG. 1, electronic device 100 may also include multiple microphones, such as microphone 104 and microphone 106. In the example of FIG. 1, microphone 104 is disposed nearer to the speaker 102 than the microphone 106 is to the speaker 102. However, in other implementations, the microphones of the electronic device 100 may be equidistant from the speaker 102 or otherwise distributed with respect to the speaker 102. Although two microphones are shown in FIG. 1, it is appreciated that the electronic device 100 may include two, three, more than three, or generally any number of microphones.

Electronic device 100 may be implemented as, for example, a portable computing device such as a desktop computer, a laptop computer, a smartphone, a peripheral device (e.g., a digital camera, headphones), a tablet device, a smart speaker, a set-top box, a content streaming device, a wearable device such as a watch, a band, a wireless headset device, wireless headphones, one or more wireless earbuds (or any in-ear, against the ear or over-the-ear device), and/or the like, or any other appropriate device that includes one or more sound-generating components and multiple microphones.

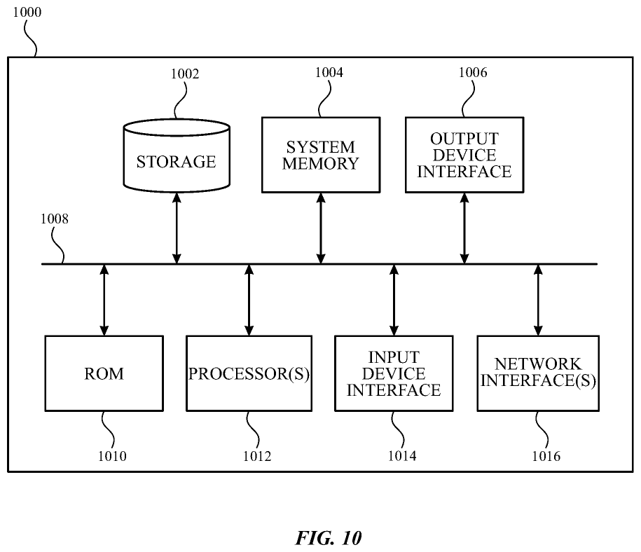

Although not shown in FIG. 1, electronic device 100 may include one or more wireless interfaces, such as one or more near-field communication (NFC) radios, WLAN radios, Bluetooth radios, Zigbee radios, cellular radios, and/or other wireless radios. Electronic device 100 may be, and/or may include all or part of, the electronic system discussed below with respect to FIG. 10.

As is discussed further below, microphones 104 and 106 and/or other microphones of the electronic device 100 may be used, in conjunction with the architectures/components described herein, for detection of audio from near-field audio sources and/or operation of the electronic device 100 based on the detection of near-field audio sources.

In the example of FIG. 1, the electronic device 100 is driving the speaker 102 to generate an audio output 114 from the electronic device. For example, processing circuitry of the electronic device 100, using power from a power source of the electronic device such as a battery of the electronic device, may drive the speaker 102 to generate audio output. In various use cases, the audio output 114 may correspond to music content or video content at the electronic device or streaming from a server, voice content from a remote participant in an audio call or an audio and/or video conferencing session, or any other audio content.

As shown in FIG. 1, while the electronic device 100 is driving the speaker 102 to generate the audio output 114, one or more far-field audio sources such as a far-field audio source 110 and/or a far-field audio source 112 may generate sound that is received by the microphone 104 and the microphone 106. For example, the far-field audio source 112 may be a user of the electronic device 100 speaking into the electronic device 100. As an example, the far-field audio source 110 may be an external noise source, such as the voice or voices of one or more other people speaking in the environment of the electronic device 100, and/or one or more other noise sources such as traffic, wind, or other background noise.

In one example use case, speaker 102 may be driven by the electronic device 100 to playback music, or audio content corresponding to video content that is playing on a display of electronic device 100 or a display of another electronic device. In this example use case, the far-field audio source 112 may be a user of the electronic device 100 speaking an audio command to a voice assistant application running on the electronic device 100. For example, the user of the electronic device 100 may speak a voice command to the voice assistant application running on the electronic device to raise or lower the volume of the audio output 114, or a voice command to stop, rewind, or fast forward playback of the audio content.

In another example use case, the electronic device 100 may be used to conduct a call or an audio and/or video conference with a remote participant. In this example use case, the speaker 102 may be driven to generate audio output 114 corresponding to the voice or voices of the remote participant. In this example use case, the far-field audio source 112 may be the user of the electronic device 100 speaking to the remote participant via the electronic device 100. For example, the microphone 104 and/or the microphone 106 may receive the voice input from the user of the electronic device and generate audio signals corresponding to the voice input. The electronic device 100 may process the audio signals and transmit a portion of the audio signals corresponding to the voice input from the user to a remote device of the remote participant.

However, as shown in FIG. 1, in addition to the audio output 114 that is intended for output from the electronic device 100, sound 116 from the speaker 102 may also be transmitted to the microphone 104, sound 118 from the speaker 102 may also be transmitted to the microphone 106, and/or sound from the speaker 102 may be transmitted to one or more other microphones of the electronic device 100, even though those portions of the sound (e.g., sound 116 and sound 118) are not intended to be projected into the microphones (e.g., microphones 104 and 106) of the electronic device.

For example, in the use case in which the electronic device 100 is being used to conduct a call or an audio and/or video conference, it is undesirable for the voice content from the remote participant that is output from the speaker 102 in the audio output 114, to be re-transmitted (e.g., echoed) back to the remote participant (e.g., as an echo of the remote participant's own voice to the remote participant).

In one or more implementations, echo-suppression operations may be performed by the electronic device 100 to suppress such an echo in the portion of the audio signals from the microphones 104 and 106 that is transmitted to the remote participant. Echo suppression operations can also be performed in other use cases, such as in the example use case described above in which a voice command to a voice assistant application is provided by a user while the speaker 102 outputs audio content. In this use case, echo-suppression operations can help prevent the sound 116 and/or the sound 118 from preventing detection of the voice command by the electronic device 100 and/or misinterpretation of the voice command by the electronic device 100.

In the example use case of a call or audio and/or video conference and/or of a voice command during audio output from the speaker, the audio output from the speaker 102 may be generated by the electronic device 100 based on audio output signals corresponding to the desired audio output. In one or more implementations, echo-suppression operations for these audio outputs can be performed by suppressing or cancelling a portion of the audio signals of the microphones 104 and 106 that matches the audio output signals. In one or more implementations, echo-suppression operations may also, or alternatively, include suppressing or cancelling a portion of the audio signals generated by the microphone 106 (e.g., the microphone furthest from the speaker 102) that corresponds to the audio signals from the microphone 104 (e.g., the microphone nearest the speaker 102), since the sound 116 at the microphone 104 may be dominant in the audio signals from the microphone 104 due to the proximity of the microphone 104 to the speaker 102.

However, even when the audio output 114 is suppressed using known audio output signals and/or audio signals from one or more microphones in close proximity to the speaker(s) generating the audio output, a residual echo of the audio output 114 can remain the echo-suppressed audio signals.

In accordance with aspects of the subject technology, the electronic device 100 may perform residual echo suppression operations to remove this residual echo from the echo-suppressed audio signals (which may be referred to herein as initial echo-suppressed audio signals, in some examples). It is also appreciated that the operations, described herein as residual echo-suppression operations when applied to initial echo-suppressed audio signals, can also be applied to audio signals from one or more microphones without performing a prior echo-suppression operation to provide direct informed echo-suppression. This can be helpful, for example, in electronic devices in which it is not feasible (e.g., due to mechanical, electrical, and/or spatial constraints) to place a microphone in close proximity to each speaker (e.g., an electronic device in which two or more microphones are uniformly distributed about (e.g., equidistant from) a speaker.

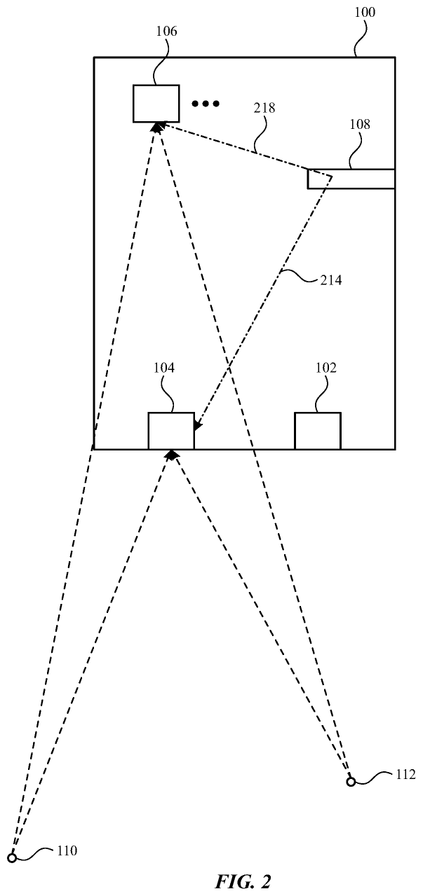

In addition to residual echo suppression and direct informed echo-suppression, the operations described herein can be applied to remove noise from microphone-generated audio signals when the noise is not known a priori (e.g., in contrast with in the use cases in which the noise received by the microphones of a device are generated by one or more speakers of that device). For example, FIG. 2 illustrates an example use case in which sound 214 generated by the sound-generating component 108 is received by the microphone 104, and sound 218 generated by the sound-generated component 108 is received by the microphone 106. In this example, the sound 214 and the sound 218 may be fan noise generated by fan of the electronic device 100 or noise generated by a haptic component of the electronic device 100 (as examples). In this example, the electronic device 100 may remove and/or suppress portions of the audio signals that are generated by the microphone 104 and the microphone 106 that correspond to the sound 214 and the sound 218, before performing device operations based on the audio signals (e.g., before transmitting audio corresponding to the user's voice, before providing the audio signals to a voice assistant application, before performing automatic noise cancellation, before performing acoustic scene mapping, before performing blind source separation, etc.) by the electronic device). As in the example of FIG. 1, in the example of FIG. 2, the far-field audio source 112 may correspond to a user speaking into the electronic device 100 and the far-field audio source 110 may be an external noise source in some use cases.

In the examples of FIGS. 1 and 2, the relative locations of the speaker 102, the sound-generating component 108, the microphone 104, and the microphone 106 (e.g., and/or any other sound-generating components and/or microphones) of the electronic device 100 (e.g., and any other electronic devices manufactured using the same manufacturing process) are known and fixed over time, regardless of the orientation, motion, location, and/or position of the electronic device 100. This is in contrast to the far-field audio source 110 and the far-field audio source 112 (e.g., and/or any other external audio sources), whose positions and relative locations to the electronic device 100 and its various microphones can change when the orientation, motion, location, and/or position of the electronic device 100 changes.

Because the relative locations of the speaker 102, the sound-generating component 108, the microphone 104, and the microphone 106 are fixed, and because the speaker 102 and the sound-generating component 108 are within the near field of both the microphone 104 and the microphone 106, a near-field impulse response may be obtained for each microphone/sound-generating component pair. For example, speaker 102 may be driven (e.g., during manufacturing of the electronic device 100) to generate a broadband audio output while input audio signals are generated by the microphone 104 and the microphone 106. In this way, a frequency-dependent transfer function between the speaker 102 and each of the microphones 104 and 106 can be measured. As another example, sound-generating component 108 may be operated (e.g., during manufacturing of the electronic device 100) to generate sound while input audio signals are generated by the microphone 104 and the microphone 106. In this way, a frequency-dependent transfer function between the sound-generating component 108 and each of the microphones 104 and 106 can be measured.

In one or more implementations, a multi-dimensional impulse response vector can be stored for each sound-generating component (e.g., the speaker 102, the sound-generating component 108 and/or any other sound-generating components) of the electronic device 100, with each dimension of the multi-dimensional impulse response vector corresponding to one of the microphones of the electronic device 100. In this way, near-field impulse response information for each sound-generating component and the microphones of the electronic device 100 can be generated and stored. During operation of the electronic device 100, when audio input is received from one or more (e.g., near-field) components of the electronic device and one or more external (e.g., far-field) audio sources (e.g., as in the use cases of FIGS. 1 and 2), portions of the audio signals generated by the microphones 104 and 106 that have a frequency-dependent signature substantially similar to the near-field impulse response information for a sound-generating component and the microphones of the electronic device 100 can be used to suppress those portions of the audio signals (e.g., by masking those portions of the audio signals, as described in further detail hereinafter).

In one or more implementations, the near-field impulse response information for each sound-generating component may be stored with a label such as a direction-of-arrival corresponding to that sound-generating component. In one or more implementations, the near-field impulse response information for the sound-generating components and the microphones of the electronic device 100 may be used to distinguish components of audio signals that correspond to near-field audio sources and far-field audio sources. In one or more implementations, the electronic device 100 may also store one or more far-field impulse response functions corresponding to one or more far-field locations and the microphones of the electronic device 100, and can use the one or more far-field impulse response functions to distinguish components of audio signals that correspond to different far-field audio sources (e.g., between a user speaking into the electronic device 100 and on or more external noise sources). In one or more implementations, the electronic device 100 may also label portions of the audio signals from the microphones 104 and 106 that correspond to one or more of the direction-of-arrival labels stored with the near-field impulse response information and/or the far-field impulse response information. In this way, subsequent processing of the audio signals can select, emphasize, and/or suppress desired portions of the audio signals using the labels, for various device operations.

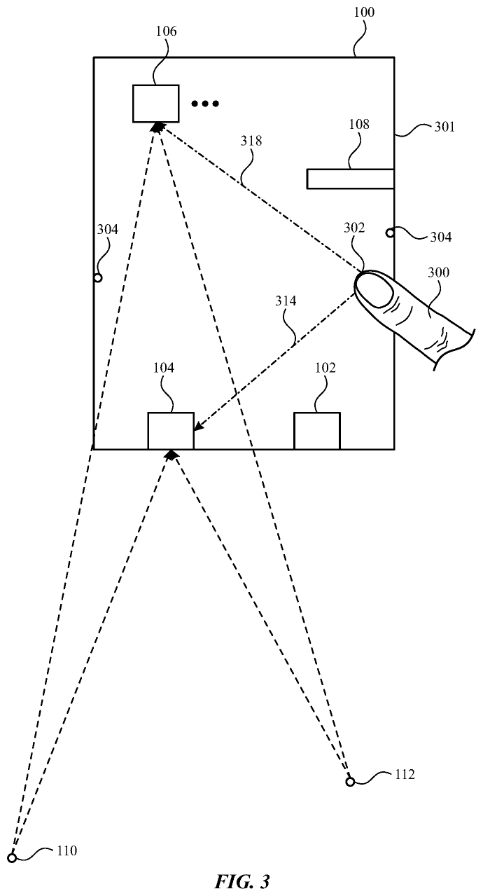

In the examples of FIGS. 1 and 2, near-field audio sources that are device components at fixed locations are described. However, in other examples, electronic device 100 may also, or alternatively, identify one or more near-field audio sources that are not device components and/or that are not at fixed locations. For example, FIG. 3 illustrates an example use case in which an external object 300 (e.g., a user's finger in this example, or another external object such as a stylus, a user's clothing, a user's hair, a table, a portion of a user's head or face, etc.) contacts a housing 301 of the electronic device 100 at a location 302. As in the examples of FIGS. 1 and 2, in the example of FIG. 3, the far-field audio source 112 may correspond to a user speaking into the electronic device 100 and the far-field audio source 110 may be an external noise source in some use cases.

Although the location 302 at which contact with an external object 300 may not be known a priori, and may change over time and/or in different use cases, the electronic device 100 may generate and/or store near-field response information for one or more locations 304 on the housing 301, and use the near-field response information for the one or more locations 304 on the housing 301 to identify portions of the audio signals from the microphones 104 and 106 that correspond to sound 314 and sound 318 from the contact.

For example, near-field impulse response information for the one or more locations 304 on the housing of the electronic device 100 may be used to classify near-field noise generated at any location on the housing (e.g., at location 302 due to external contact with the housing) as contact noise generated at one of the one or more locations (e.g., even if the location 302 of the contact is not exactly the same as any of the one or more locations 304 for which the near-field impulse response information was generated). In this way, the near-field impulse response information for the one or more locations 304 may be used to identify and/or remove portions of the audio signals from the microphone 104 and the microphone 106 caused by contact noise.

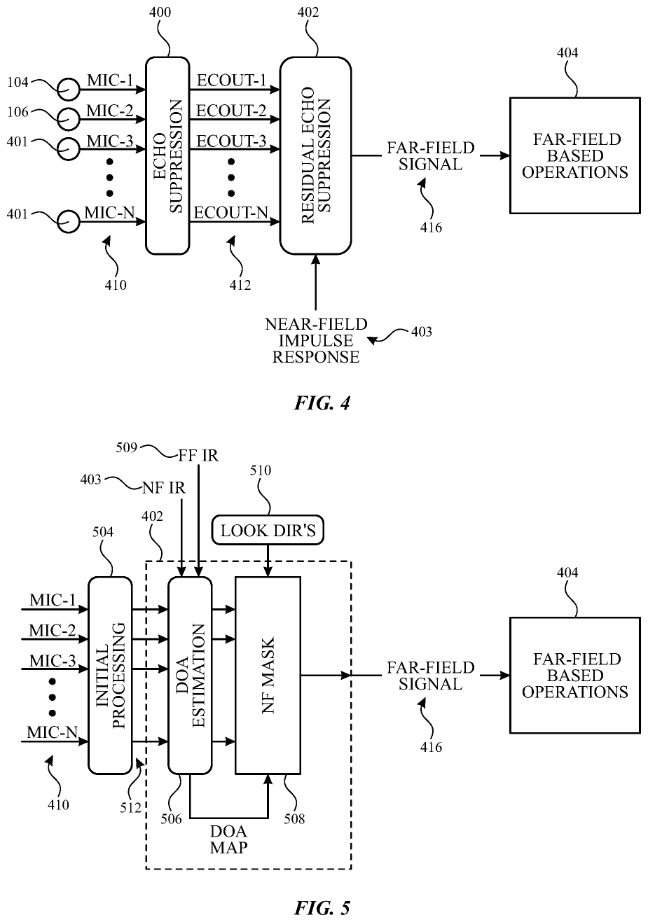

FIG. 4 illustrates a block diagram of an example architecture for performing residual echo suppression in accordance with one or more implementations. For explanatory purposes, the architecture of FIG. 4 is primarily described herein as being implemented by the electronic device 100 of FIG. 1. However, the architecture of FIG. 4 is not limited to the electronic device 100 of FIG. 1, and may be implemented may be implemented by one or more other components and other suitable devices. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The architecture of FIG. 4 may include the microphones 104 and 106 of FIG. 1, additional microphones 401, an echo suppression module 400, a residual echo suppression module 402, and/or a far-field based operations module 404.

In the example of FIG. 4, audio signals 410 may be generated by the microphones 104, 106, and 401 (e.g., of the electronic device 100). For example, the audio signals 410 may be generated in response to incoming audio input from one or more near-field and/or far-field audio sources, while the electronic device 100 drives the speaker 102 to generate the audio output 114, as in the example of FIG. 1. In one or more implementations, the audio signals 410 may span a time duration including multiple frames. Moreover, the frames of the audio signals 410 may span multiple audio frequencies, such that each time frame of the audio signals 410 may be categorized based on respective frequency sub-bands.

As shown in FIG. 4, the echo suppression module 400 may generate initial echo-suppressed audio signals 412 (e.g., an “ECOut” signal for each of N microphones). For example, the echo suppression module 400 may cancel, filter, or otherwise suppress a portion of the audio signals 410 corresponding to the audio output 114 from the speaker 102. For example, the echo suppression module 400 may generate a signal filter for each of the audio signals 410, using an audio output signal that is being used to drive the speaker 102 and apply the signal filter to the audio signals 410 to generate the initial echo-suppressed audio signals 412. In another example, an audio signal 410 from one or more the microphones 104, 106, and 401 (e.g., one or more microphones disposed in close proximity to the speaker 102, such as the microphone 104), may be used to generate a signal filter corresponding to the audio output 114, and the signal filter may be applied to the audio signals 410 of the others of the microphones 104, 106, and 401 to generate the initial echo-suppressed audio signals 412. As discussed herein, the initial echo-suppressed audio signals 412 may include a residual echo of the audio output 114 from the speaker 102.

In the example of FIG. 4, the residual echo suppression module 402 may generate a far-field signal 416 (e.g., a residual echo-suppressed audio signal), such as by removing a residual-echo portion of the audio signals using a near-field impulse response 403 corresponding to relative locations of the speaker 102 and the microphones 104, 106, and 401. For example, the residual echo suppression module 402 may remove the residual-echo portion of the audio signals by removing the residual-echo portion of the audio signals from the initial echo-suppressed audio signals 412 (using the near-field impulse response 403 corresponding to the relative locations of the speaker and the plurality of microphones), as described in further detail hereinafter in connection with, for example FIG. 5.

In one or more implementations, the far-field based operation module 404 may include transmitting the far-field signal 416 to a remote device of a remote participant in call or an audio and/or video conference, providing the far-field signal 416 to a voice assistant application and executing a voice command in the far-field signal 416 with the voice assistant application, and/or providing the far-field signal 416 to an audio signal recorder application, a dictation application, or any other application or process that utilizes audio input to the electronic device from the external environment of the electronic device.

FIG. 5 illustrates further details of architecture of FIG. 4, in accordance with one or more implementations. As illustrated in FIG. 5, the audio signals 410 from two or more microphones of an electronic device, such as electronic device 100, may be provided to an initial processing module 504. The initial processing module 504 may be, or include, the echo suppression module 400 of FIG. 4, and/or one or more additional processing modules. In one or more implementations, the initial processing module 504 may perform one or more signal conditioning, filtering, and/or transformation operations to generate processed audio signals 512 that may be provided to the residual echo suppression module 402. In one or more implementations, the initial processing module 504 may perform a frequency transform operation (e.g., Fourier transform operation such as a Fast Fourier Transform (FFT)) on the audio signals 410 to generate one or more frequency space audio signals. In various implementations, the frequency transform may be performed individually on the audio signals of each microphone to generate a frequency space audio signal for each microphone, and/or the frequency transform may be performed to generate a combined frequency space audio signal that incorporates the audio signals from multiple (e.g., all) of the microphones.

As shown in FIG. 5, the residual echo suppression module 402 may include a direction-of-arrival (DOA) estimation module 506 and a near-field (NF) masking module 508. As shown, the DOA estimation module 506 may generate DOA information (e.g., a DOA map) and provide the DOA information to the NF masking module 508. The NF masking module 508 may generate a near-field (NF) mask based on the DOA information provided by the DOA estimation module 506, and apply the NF mask to the audio signals 512 to generate the far-field signal 416 to be provided to the far-field based operation module 404. In one or more implementations, the DOA estimation module 506 performs a frequency-dependent DOA estimation using the directional NF impulse response (e.g., near-field impulse response(s) 403) for each of one or more speakers to generate a sub-band (e.g., frequency-dependent) DOA map.

For example, the residual echo suppression module 402 may remove a residual-echo portion of the audio signals 410 from the processed audio signals 512 (e.g., frequency space audio signals and/or initial echo-suppressed audio signals) by identifying, with the DOA estimation module 506, various portions of the processed audio signals 512 corresponding to various respective directions-of-arrival. In one or more implementations, identifying the various portions of the processed audio signals 512 that correspond to the various respective directions-of-arrival may include binning the various portions of the processed audio signals 512 into time-frequency bins, and generating a DOA map that indicates the DOA of the dominant audio source for each of the time-frequency bins. For example, the DOA map may map (e.g., based on a correspondence between a shape of a time-frequency response in the audio signals and a time-frequency response in the NF impulse response information for one or more labeled directions-of-arrival) one or more of the various portions (e.g., the time-frequency bins) of the processed audio signals 512 to a labeled direction-of-arrival for the dominant audio source detected in that portion (e.g., bin).

In this way, and because the labeled DOA(s) of the speaker 102 (e.g., and/or any other near-field sound-generating components such as other speakers, fans, haptic components, etc. of the electronic device) are known, the DOA map can be used to identify time-frequency bins of the processed audio signals 512 in which the speaker 102 (e.g., and/or any other near-field sound-generating components such as other speakers, fans, haptic components, etc.) contributes to (e.g., is the dominant contributor to) the audio input. The DOA map and the pre-labeled DOAs can thus be used to identify time-frequency bins in which any speaker or sound-generating component was active and dominant, and/or to isolate the time-frequency bins when any individual speaker or sound-generating was dominant and active.

The NF masking module 508 may generate a mask (e.g., an NF mask) using a predetermined direction-of-arrival (e.g., a look direction 510 or “Look Dir”) corresponding to the speaker 102 and/or any other near-field audio sources, and the identified various portions of the processed audio signals 512 corresponding to the various respective directions-of-arrival (e.g., in the DOA map). The NF masking module 508 may then apply the mask to the processed audio signals 512. For example, the NF mask may be a vector, an array, or other structure of mask values (e.g., gain values) having a high value for time-frequency bins in which the processed audio signals 512 do not include contributions from the speaker 102 and/or any other sound-generating components (e.g., from a direction-of-arrival of the speaker 102 and/or any other sound-generating components), and a low value for the time-frequency bins in which the processed audio signals 512 do include contributions from the speaker 102 and/or any other sound-generating components (e.g., from a direction-of-arrival of the speaker 102 and/or any other sound-generating components). In this example, applying the NF mask may include passing any time-frequency bins with high mask values through to the far-field based operations module 404 in the far-field signal 416 (e.g., and removing time-frequency bins with low mask values). In this way, the electronic device 100 (e.g., the residual echo suppression module 402) can suppress a residual-echo portion of the processed audio signals 512 using a near-field impulse response 403 for the speaker 102 and/or any other speakers of the electronic device, a fan-noise portion of the processed audio signals 512 using a near-field impulse response 403 corresponding to relative locations of the microphones and a fan of the electronic device 100, and/or any other noise portion of the processed audio signals 512 that corresponds to direction-of-arrival for which a near-field impulse response 403 is available.

The architecture of FIGS. 4 and/or the architecture of FIG. 5 may provide a multi-microphone near-field detection based residual echo suppressor that uses a set of precomputed speaker-to-microphone near-field directional impulse responses, along with a frequency dependent direction-of-arrival (DOA) estimator (e.g., DOA estimation module 506), to locate the speakers and estimate a frequency dependent mask (e.g., the NF mask) based on the DOA map. As discussed herein, the NF mask may be derived such that the mask values are high for time-frequency bins of the audio signals 410 and/or the processed audio signals 512 when speaker echo is not present, and the mask values are low for time-frequency bins of the audio signals 410 and/or the processed audio signals 512 for which the DOA(s) of the speaker(s) were detected. The NF mask, when applied to the audio signals 410 and/or the processed audio signals 512 to suppress or remove the time-frequency bins for which the mask values are low before, can yield cleaner microphone signals without residual echo from the speaker(s). The architecture of FIGS. 4 and/or the architecture of FIG. 5 can also be applied in any use cases in which the DOA of a signal of interest is known. For example, the NF masking module 508 may also generate individual masks for each of one or more near-field noise sources as well as one or more far-field noise sources. As one additional example that is described herein, the NF masking module 508 may generate a sub-band (e.g., frequency dependent) mask for a fan of the electronic device 100 (e.g., a sub-band mask that indicates a probability of when fan noise is active in the audio signals 410 and/or the processed audio signals 512). In various implementations, a sub-band fan-noise mask can be used to suppress the fan-noise in the audio signals 410 and/or the processed audio signals 512 and/or to inform other systems on-board the electronic device 100 of when fan noise is or may be present. In one or more implementations, one or more far-field impulse responses (FF IRs) 509 may also be provided to the DOA estimation module 506. In one or more implementations, the DOA estimation module 506 label one or more time-frequency bins of the audio signals 410 and/or the processed audio signals 512 as corresponding to one or more far-field DOAs, using the FF IRs 509.

In the examples of FIGS. 4 and 5, the DOA estimation module 506 utilizes NF impulse responses 403 to remove a residual echo portion of an audio signal from the audio signal. It is also appreciated that a DOA map generated by the DOA estimation module 506 (e.g., using the NF IRs 403 and/or the FF IRs 509) may be utilized for other device operations that use audio signals from the microphones of the electronic device 100 as inputs.

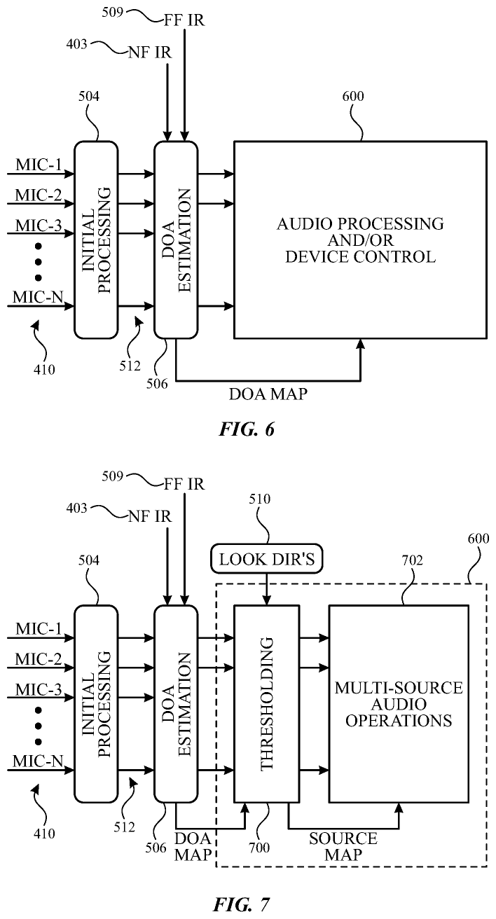

For example FIG. 6 illustrates an example architecture for operating an electronic device such as the electronic device 100 of FIG. 1 using audio signals, in accordance with one or more implementations. In the example of FIG. 6, as in the example of FIG. 5, the audio signals 410 from two or more microphones of an electronic device, such as electronic device 100, may be provided to an initial processing module 504. In one or more implementations, the initial processing module 504 may perform one or more signal conditioning, filtering, echo-suppression, and/or transformation operations to generate processed audio signals 512 that may be provided to audio processing and/or device control operations 600. In one or more implementations, the initial processing module 504 may perform a frequency transform operation (e.g., Fourier transform operation such as a Fast Fourier Transform (FFT)) on the audio signals 410 to generate one or more frequency space audio signals (e.g., processed audio signals 512). In various implementations, the frequency transform may be performed individually on the audio signals of each microphone to generate a frequency space audio signal for each microphone, and/or the frequency transform may be performed to generate a combined frequency space audio signal that incorporates the audio signals from all of the microphones.

As illustrated in FIG. 6, an electronic device such as electronic device 100 obtain audio signals 410 from microphones of the device, identify (e.g., using DOA estimation module 506) a portion of the audio signals corresponding to a sound-generating component (e.g., speaker 102, sound-generating component 108, and/or the like) using near-field impulse response information (e.g., NF IR(s) 403) and/or far-field impulse response information (e.g., FF IR(s) 509), and operate the electronic device based on the audio signals and the identified portion of the audio signals (e.g., by performing audio processing and/or device control operations 600). For example, as described above in connection with FIG. 5, a DOA map generated by DOA estimation module 506 may identify various portions (e.g., time-frequency bins) of the audio signals 410 and/or the processed audio signals 512 that correspond to various DOA labels. In one or more implementations, the audio processing and/or device control operations 600 may include any or all of residual echo suppression, blind source separation, automatic noise cancellation, acoustic scene mapping, voice assistance, audio and/or video conference, telephony, or the like.

For example, in one or more implementations, the audio processing and/or device control operations 600 may include operating the electronic device 100 based on the audio signals 410 and the identified portion of the audio signals by removing the identified portion of the audio signals from the audio signals, and operating the electronic device 100 based on a remaining portion of the audio signals. For example, the audio processing and/or device control operations 600 may include operating the electronic device 100 based on the remaining portion of the audio signals by transmitting the remaining portion of the audio signals (e.g., far-field signal 416) to a remote device (e.g., as part of a telephone call or an audio and/or video conferencing session).

As another example, in one or more implementations, the audio processing and/or device control operations 600 may include operating the electronic device 100 based on the remaining portion of the audio signals by determining whether voice activity is present in the remaining portion of the audio signals, and providing the remaining portion of the audio signals to a voice assistant application at the electronic device 100, if the voice activity is present.

In one or more implementations, the audio processing and/or device control operations 600 may include removing the identified portion of the audio signals from the audio signals by applying, to the audio signals, a gain mask (e.g., the NF mask of FIG. 5) that is based on a direction-of-arrival of the portion of the audio signals.

In the example of FIG. 6, in one or more implementations, the operations of the initial processing module 504 may include performing, prior to removing the identified portion of the audio signals as part of the audio processing and/or device control operations 600, an echo suppression operation to remove a first portion of the audio signals from the audio signals based on a known output from a speaker (e.g., speaker 102) of the electronic device 100. In this example, removing the identified portion of the audio signals as part of the audio processing and/or device control operations 600 may include applying the gain mask to the audio signals to remove the identified portion of the audio signals following the echo suppression operation.

In one or more implementations, DOA estimation module 506 may identify an additional portion of the audio signals (e.g., the audio signals 410 and/or the processed audio signals 512) corresponding to an additional sound-generating component of the electronic device 100 (e.g., the sound-generating component 108) using additional near-field impulse response information for the additional sound-generating component (e.g., an additional NF impulse response 403 for the sound-generating component 108 stored in memory of the electronic device 100).

In one or more implementations, DOA estimation module 506 may also identify an additional portion of the audio signals corresponding to a far-field audio source using far-field impulse response information (e.g., a far-field impulse response 509) for a far-field location and two or more microphones (e.g., microphones 104, 106, and/or 401). For example, the far-field impulse response information for the far-field location and the plurality of microphones may include a predetermined far-field impulse response 509 determined (e.g., during manufacturing of the electronic device) by generating a known sound at the far-field location, obtaining an audio signal with each of the microphones, determining a transfer function based on the known sound and each of the obtained audio signals and/or a combination of the obtained signals, and storing the obtained transfer functions as the far-field impulse response 509, labeled with a DOA for the far-field location, for each microphone and/or a combination of the microphones.

In one or more implementations, DOA estimation module 506 may also identify an additional portion of the audio signals corresponding to a contact between the electronic device and an external object (e.g., the external object 300 of FIG. 3) using additional near-field impulse response information (e.g., one or more near-field impulse response transfer functions between one or more locations on the housing 301 of the electronic device and each microphone of the electronic device, as described herein).

In one or more implementations, the audio processing and/or device control operations 600 may include audio processing operations that identify multiple audio sources in the audio signals 410 and/or the processed audio signals 512, and multi-source audio operations that utilize the identifications of the multiple sources. For example, FIG. 7 illustrates an example in which the audio processing and/or device control operations 600 include thresholding operations 700 and multi-source audio operations 702.

In the example of FIG. 7, the DOA estimation module 506 may identify the portion of the audio signals corresponding one or more near-field and/or far-field audio sources, by generating a DOA map corresponding to the audio signals (e.g., the audio signals 410 and/or the processed audio signals 512), such as using the NF IR(s) 403 and/or the FF IR(s) 509 as described herein in connection with, for example, FIG. 5. In this example, the audio processing and/or device control operations 600 may include applying a thresholding operation 700 to the DOA map to generate a source map. In one or more implementations, the source map may be a voice activity detection (VAD) map. As shown, the thresholding operation 700 may output the source map to a subsequent process (e.g., multi-source audio operations 702) at the electronic device. In one or more implementations, the multi-source audio operations 702 may include a filtering operation (e.g., parametric multichannel Wiener filter (PMWF) operation, such as a PMWF noise covariance calculation), a blind source separation operation, an acoustic scene mapping operation, a noise cancelling operation, or a voice activity detection operation.

For example, the architecture of FIG. 7 may provide an auxiliary voice activity detection (VAD) system for the electronic device 100, in one or more implementations. For example, the architecture of FIG. 7 may be operated as a sub-band VAD which can inform the multi-source audio operations 702 (e.g., a BSS) when each speaker and/or other noise-generating component of the electronic device is active, thus facilitating an improved quality of the subsequent multi-source audio operations 702. In one or more implementations, the thresholding operation 700 may receive, as an input, one or more look directions 510 in addition to the incoming audio signal(s) and the DOA map. The thresholding operation 700 may determine one or more thresholds to be applied to the DOA map using the look directions 510.

In one or more implementations, one or more components of the echo suppression module 400, the residual echo suppression module 402, the far-field based operations module 404, the initial processing module 504, the DOA estimation module 506, the NF masking module 508, the audio processing and/or device control operations 600, the thresholding operation 700 and/or the multi-source audio operations 702 of FIGS. 4-7 may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices), and/or a combination of both. In one or more implementations, some or all of the depicted components may share hardware and/or circuitry, and/or one or more of the depicted components may utilize dedicated hardware and/or circuitry. Additional features and functions of these modules according to various aspects of the subject technology are further described in the present disclosure.

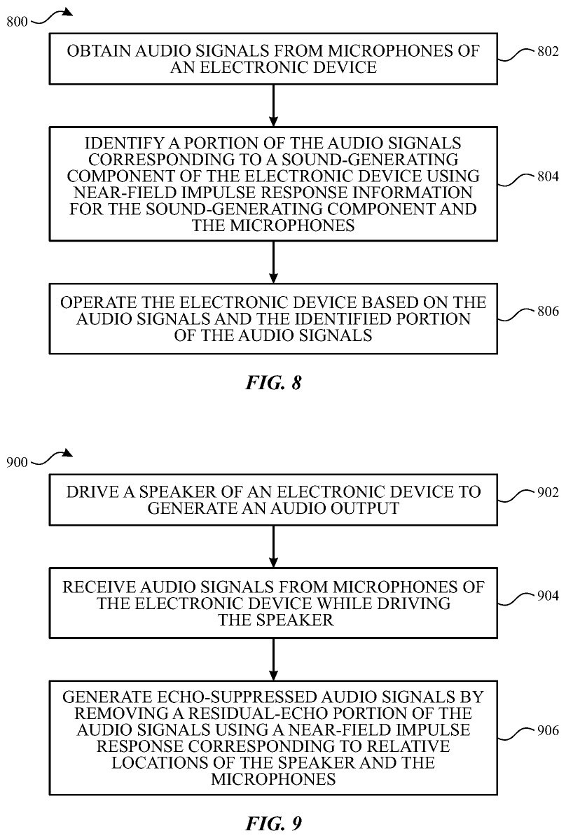

FIG. 8 illustrates a flow diagram of an example process for operating an electronic device, in accordance with one or more implementations. For explanatory purposes, the process 800 is primarily described herein with reference to the electronic device 100 of FIGS. 1-3. However, the process 800 is not limited to the electronic device 100 of FIGS. 1-3, and one or more blocks (or operations) of the process 800 may be performed by one or more other components and other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In the example of FIG. 8, at block 802, an electronic device (e.g., electronic device 100) obtains audio signals (e.g., audio signals 410 and/or processed audio signals 512) from microphones (e.g., microphone 104, microphone 106, and/or one or more microphones 401) of the electronic device. As described above in connection with the examples of FIGS. 1-3, the audio signals may be generated by the microphones responsive to audio input from one or more components of the electronic device (e.g., one or more speakers, such as speaker 102, and/or one or more other sound-generating components, such as sound-generating component 108) and/or one or more external audio sources, such as the far-field audio source 110 and/or the far-field audio source 112. As described herein, sound-generating components of the electronic device may be disposed at near-field locations with respect to each of the microphones.

At block 804, the electronic device (e.g., DOA estimation module 506) identifies a portion (e.g., one or more time-frequency bins) of the audio signals corresponding to a sound-generating component (e.g., a speaker, such as speaker 102, or another sound-generating component such as sound-generating component 108) of the electronic device using near-field impulse response information (e.g., NF impulse response(s) 403) for the sound-generating component and the microphones. In one or more implementations, the microphones include at least a first microphone (e.g., microphone 104) and a second microphone (e.g., microphone 106), and the near-field impulse response information includes a first transfer function between the sound-generating component and the first microphone and a second transfer function between the sound-generating component and the second microphone. In one or more implementations, the near-field impulse response information includes transfer function (e.g., a NF IR 403) between each of one or more sound-generating components and each of two or more microphones.

At block 806, the electronic device may be operated based on the audio signals and the identified portion of the audio signals. For example, operating the electronic device based on the audio signals and the identified portion of the audio signals may include performing any or all of the operations of the far-field based operations module 404 of FIG. 4 and/or FIG. 5, the audio processing and/or device control operations 600 of FIG. 6, and/or the multi-source audio operations 702 of FIG. 7. In various implementations, operating the electronic device based on the audio signals and the identified portion of the audio signals may include performing any or all of residual echo suppression operations, blind source separation operations, automatic noise cancellation operations, acoustic scene mapping operations, voice assistance operations, audio and/or video conferencing operations, telephony operations, or the like, as described herein (e.g., in connection with the audio processing and/or device control operations 600 of FIG. 6).

In one or more implementations, the process 800 may also include identifying an additional portion (e.g., one or more additional time-frequency bins) of the audio signals corresponding to a far-field audio source (e.g., far-field audio source 110 and/or far-field audio source 112) external to the electronic device using far-field impulse response information (e.g., one or more FF IRs 509) for a far-field location and the microphones.

As discussed herein, operating an electronic device based on audio input can include performing residual echo suppression, in one or more implementations. FIG. 9 illustrates a flow diagram of an example process for residual echo suppression in accordance with one or more implementations. For explanatory purposes, the process 900 is primarily described herein with reference to the electronic device 100 of FIGS. 1-3. However, the process 900 is not limited to the electronic device 100 of FIGS. 1-3, and one or more blocks (or operations) of the process 900 may be performed by one or more other components and other suitable devices. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

In the example of FIG. 9, at block 902, an electronic device (e.g., electronic device 100) drives a speaker (e.g., speaker 102) of the electronic device to generate audio output (e.g., audio output 114). As described herein, the audio output may include voice content from a remote participant in a call or an audio and/or video conferencing session, media content corresponding to audio and/or video media, or any other audio content. In one or more implementations, the electronic device may drive more than one speaker to generate audio output.

At block 904, the electronic device may receive audio signals (e.g., audio signals 410 and/or processed audio signals 512) from microphones (e.g., microphone 104, microphone 106, and/or one or more microphones 401) of the electronic device while driving the speaker to generate the audio output (e.g., as indicated in FIG. 1). As described above in connection with, for example, FIGS. 1, 4, and 5, the audio signals may include portions at various frequencies that correspond to the audio output of the speaker.

At block 906, the electronic device (e.g., residual echo suppression module 402) may generate echo-suppressed audio signals (e.g., far-field signals 416) by removing a residual-echo portion of the audio signals using a near-field impulse response (e.g., near-field impulse response 403) corresponding to relative locations of the speaker and the microphones. For example, the near-field impulse response corresponding to the relative locations of the speaker and the microphones may be a frequency-dependent near-field impulse response corresponding to the relative locations of the speaker and the microphones. For example, the frequency-dependent near-field impulse response corresponding to the relative locations of the speaker and the microphones may include a sub-band near-field impulse response for the speaker and each of the microphones (e.g., stored as a multi-dimensional vector as discussed herein in connection with some examples).

In one or more implementations, removing the residual-echo portion of the audio signals includes generating (e.g., by echo suppression module 400) initial echo-suppressed audio signals (e.g., initial echo-suppressed audio signals 412) by cancelling a portion of the audio signals corresponding to the audio output from the speaker, and removing (e.g., by residual echo suppression module 402) the residual-echo portion of the audio signals from the initial echo-suppressed audio signals using the near-field impulse response corresponding to the relative locations of the speaker and the microphones (e.g., as described above in connection with FIG. 4).

In one or more implementations, removing the residual-echo portion of the audio signals from the initial echo-suppressed audio signals includes identifying (e.g., by DOA estimation module 506) various portions (e.g., time-frequency bins) of the initial echo-suppressed audio signals corresponding to various respective directions-of-arrival, generating (e.g., by NF masking module 508) a mask (e.g., a NF mask) using a predetermined direction-of-arrival of the speaker (e.g., a look direction 510) and the identified various portions of the initial echo-suppressed audio signals corresponding to the various respective directions-of-arrival (e.g., in a DOA map), and applying (e.g., by NF masking module 508) the mask to the initial echo-suppressed audio signals (e.g., as described above in connection with FIG. 5).

In one or more implementations, the process 900 may also include suppressing (e.g., by NF masking module 508) a fan-noise portion of the initial echo-suppressed audio signals using a near-field impulse response corresponding to relative locations of the microphones and a fan (e.g., sound-generating component 108) of the electronic device. In one or more implementations, the process 900 may also include suppressing (e.g., by NF masking module 508) a contact-noise portion of the initial echo-suppressed audio signals using a near-field impulse response corresponding to relative locations of the microphones and one or more locations on a housing (e.g., the housing 301) of the electronic device.

As described above, one aspect of the present technology is the gathering and use of data available from specific and legitimate sources for providing user information in association with processing audio and/or non-audio signals. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for operating an electronic device based on audio input. Accordingly, use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device based on audio input, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 10 illustrates an electronic system 1000 with which one or more implementations of the subject technology may be implemented. The electronic system 1000 can be, and/or can be a part of, one or more of the electronic device 100 shown in FIGS. 1-3. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010. From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM.

The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one” of preceding a series of items, with the term “and” or “or” to separate any of the items, modifies the list as a whole, rather than each member of the list (i.e., each item). The phrase “at least one” of does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An electronic device, comprising:
a plurality of microphones;
a sound-generating component;
memory storing near-field impulse response information for the sound-generating component and the plurality of microphones; and
processing circuitry configured to:
obtain audio signals from the plurality of microphones;
identify a portion of the audio signals corresponding to the sound-generating component using the near-field impulse response information; and
operate the electronic device based on the audio signals and the identified portion of the audio signals.

2. The electronic device of claim 1, wherein the processing circuitry is configured to operate the electronic device based on the audio signals and the identified portion of the audio signals by:
removing the identified portion of the audio signals from the audio signals; and
operating the electronic device based on a remaining portion of the audio signals.

3. The electronic device of claim 2, wherein the processing circuitry is configured to operate the electronic device based on the remaining portion of the audio signals by transmitting the remaining portion of the audio signals to a remote device.

4. The electronic device of claim 2, wherein the processing circuitry is configured to operate the electronic device based on the remaining portion of the audio signals by:
determining whether voice activity is present in the remaining portion of the audio signals; and
providing the remaining portion of the audio signals to a voice assistant application at the electronic device if the voice activity is present.

5. The electronic device of claim 2, wherein the processing circuitry is configured to remove the identified portion of the audio signals from the audio signals by applying, to the audio signals, a gain mask that is based on a direction-of-arrival of the portion of the audio signals.

6. The electronic device of claim 5, wherein the sound-generating component comprises a speaker, and wherein the processing circuitry is further configured to:
perform, prior to removing the identified portion of the audio signals, an echo suppression operation to remove a first portion of the audio signals from the audio signals based on a known output from the speaker; and
apply the gain mask to the audio signals to remove the identified portion of the audio signals following the echo suppression operation.

7. The electronic device of claim 1, wherein the processing circuitry is configured to:
identify the portion of the audio signals by generating a direction-of-arrival map corresponding to the audio signals; and
operate the electronic device based on the audio signals and the identified portion of the audio signals by:
applying a thresholding operation to the direction-of-arrival map to generate a labeled direction-of-arrival map; and
providing the labeled direction-of-arrival map to a subsequent process at the electronic device.

8. The electronic device of claim 7, wherein the subsequent process comprises a filtering operation, a blind source separation operation, an acoustic scene mapping operation, a noise cancelling operation, or a voice activity detection operation.

9. The electronic device of claim 1, wherein the sound-generating component comprises a fan or a haptic component disposed within a housing of the electronic device.

10. The electronic device of claim 1, further comprising an additional sound-generating component, wherein the memory stores additional near-field impulse response information for the additional sound-generating component and the plurality of microphones, and wherein the processing circuitry is further configured to identify an additional portion of the audio signals corresponding to the additional sound-generating component using the additional near-field impulse response information.

11. The electronic device of claim 1, wherein the processing circuitry is further configured to identify an additional portion of the audio signals corresponding to a far-field audio source using far-field impulse response information for a far-field location and the plurality of microphones.

12. The electronic device of claim 1, wherein the processing circuitry is further configured to identify an additional portion of the audio signals corresponding to a contact between the electronic device and an external object using additional near-field impulse response information.

13. The electronic device of claim 1, wherein the plurality of microphones comprises a first microphone and a second microphone, wherein the first microphone is nearer to the sound-generating component than the second microphone is to the sound-generating component.

14. The electronic device of claim 1, wherein the plurality of microphones comprises a first microphone and a second microphone, wherein the first microphone and the second microphone are equidistant from the sound-generating component.

15. A method, comprising:
obtaining audio signals from a plurality of microphones of an electronic device;
identifying a portion of the audio signals corresponding to a sound-generating component of the electronic device using near-field impulse response information for the sound-generating component and the plurality of microphones; and
operating the electronic device based on the audio signals and the identified portion of the audio signals.

16. The method of claim 15, wherein the plurality of microphones comprises at least a first microphone and a second microphone, and wherein the near-field impulse response information comprises a first transfer function between the sound-generating component and the first microphone and a second transfer function between the sound-generating component and the second microphone.

17. The method of claim 15, further comprising identifying an additional portion of the audio signals corresponding to a far-field audio source external to the electronic device using far-field impulse response information for a far-field location and the plurality of microphones.

18. A method comprising:
driving a speaker of an electronic device to generate audio output;
receiving audio signals from a plurality of microphones of the electronic device while driving the speaker to generate the audio output; and
generating echo-suppressed audio signals by removing a residual-echo portion of the audio signals using a near-field impulse response corresponding to relative locations of the speaker and the plurality of microphones.

19. The method of claim 18, wherein the near-field impulse response corresponding to the relative locations of the speaker and the plurality of microphones is a frequency-dependent near-field impulse response corresponding to the relative locations of the speaker and the plurality of microphones.

20. The method of claim 18, wherein removing the residual-echo portion of the audio signals comprises:
generating initial echo-suppressed audio signals by cancelling a portion of the audio signals corresponding to the audio output from the speaker; and
removing the residual-echo portion of the audio signals from the initial echo-suppressed audio signals using the near-field impulse response corresponding to the relative locations of the speaker and the plurality of microphones.

21. The method of claim 20, wherein removing the residual-echo portion of the audio signals from the initial echo-suppressed audio signals comprises:
identifying various portions of the initial echo-suppressed audio signals corresponding to various respective directions-of-arrival;
generating a mask using a predetermined direction-of-arrival of the speaker and the identified various portions of the initial echo-suppressed audio signals corresponding to the various respective directions-of-arrival; and
applying the mask to the initial echo-suppressed audio signals.

22. The method of claim 20, further comprising suppressing a fan-noise portion of the initial echo-suppressed audio signals using a near-field impulse response corresponding to relative locations of the plurality of microphones and a fan of the electronic device.
